(19) United States
(12) Patent Application Publication
(10) Pub. No.: US 2014/0376431 A1
(43) Pub. Date: Dec. 25, 2014

(54) PORTABLE WIRELESS ROUTER

(71) Applicants: HON HAI PRECISION INDUSTRY CO., LTD., New Taipei (TW); HONG FU JIN PRECISION INDUSTRY (SHENZHEN) CO., LTD., Shenzhen (CN)

(72) Inventor: HONG LI, Shenzhen (CN)

(73) Assignees: HON HAI PRECISION INDUSTRY CO., LTD., New Taipei (TW); HONG FU JIN PRECISION INDUSTRY (SHENZHEN) CO., LTD., Shenzhen (CN)

(21) Appl. No.: 13/971,820

(22) Filed: Aug. 20, 2013

(30) Foreign Application Priority Data
Jun. 19, 2013 (CN) 2013102431483

(51) Int. Cl. H04W 52/02

(52) U.S. Cl. CPC H04W 52/02
USPC 370/311

(57) ABSTRACT

A portable wireless router includes a network interface, a power over ethernet (PoE) module connected to the network interface, and a power source interface to connect an external power source to the portable wireless router. A power processing module is connected to the power source interface and to convert power provided by the external power source connected to the power source interface to work voltage of the portable wireless router. A wireless access point is to provide wireless access to the wired network. A first switch is to connect the PoE module to the wireless access point. A second switch is to connect the power processing module to the wireless access point. A control chip is to turn the first switch and the second switch on and off.

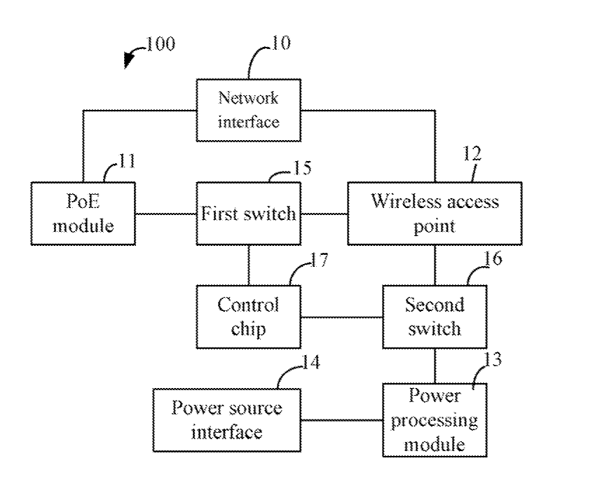

### BACKGROUND

1. Technical Field

The present disclosure relates to wireless routers, and particularly to a portable wireless router.

2. Description of Related Art

A conventional wireless router needs an adapter for connecting the router to an external power source. It would be inconvenient for a user to carry about a router and an adapter around, thus decreasing the mobility of the conventional routers.

### BRIEF DESCRIPTION OF THE DRAWINGS

Many aspects of the present disclosure should be better understood with reference to the following drawing.

The drawing is a block diagram of a portable wireless router, in accordance with an exemplary embodiment.

### DETAILED DESCRIPTION

Embodiments of the present disclosure are described, with reference to the accompanying drawing.

The drawing shows an embodiment of a portable wireless router 100. The router 100 includes a network interface 10, a power over ethernet (PoE) module 11, a wireless access point 12, a power processing module 13, a power source interface 14, a first switch 15, a second switch 16, and a control chip 17. The network interface 10 connects the router 100 to a network, such as the Internet for example. The PoE module 11 is connected to the network interface 10, and provides power to the router 100 via PoE technology. The wireless access point 12 is connected to the network interface 10 to provide wireless access to the wired network. The power processing module 13 is connected to the power source interface 14. The power source interface 14 can be connected to an external power source. The power processing module 13 converts power provided by the external power source connected to the power source interface 14 to a work voltage of the router 100. The PoE module 11 is connected to the wireless access point 12 via the first switch 15. The power processing module 13 is connected to the wireless access point 12 via the second switch 16. The control chip 17 can turn the first switch 15 and the second switch 16 on and off.

In this embodiment, when the power source interface 14 is connected to an external power source, the control chip 17 turns on the second switch 16 and turns off the first switch 15. When the power source interface 14 is in an idle state, the control chip 17 turns on the first switch 15 and turns off the second switch 16. With such configuration, when the router 100 is connected to an external power source, the router 100 obtains power from the external power source. When the router 100 is not connected to an external power source, the router 100 obtains power via the PoE technology. Furthermore, because the power processing module 13 is arranged within the router 100, there is no need to carry an adapter as well as the router 100.

In this embodiment, the router 100 provides an access point (AP) mode and a router mode. The control chip 17 switches the router 100 between the AP mode and the router mode according to user input.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A portable wireless router comprising:
a network interface;
a power over ethernet (PoE) module connected to the network interface;
a power source interface to connect an external power source to the portable wireless router;
a power processing module connected to the power source interface, and to convert power provided by the external power source connected to the power source interface to work voltage of the portable wireless router;
a wireless access point to provide wireless access to the wired network;
a first switch to connect the POE module to the wireless access point;
a second switch to connect the power processing module to the wireless access point; and
a control chip to turn the first switch and the second switch on and off.

2. The portable wireless router as described in claim 1, wherein the control chip turns on the second switch and turns off the first switch when the power source interface is connected to the external power source.

3. The portable wireless router as described in claim 1, wherein the control chip turns on the first switch and turns off the second switch when the power source interface is in an idle state.

4. The portable wireless router as described in claim 1, wherein the control chip switches the portable wireless router between a access point (AP) mode and a router mode.
